(19) United States
(12) Patent Application Publication
(10) Pub. No.: US 2020/0382243 A1
(43) Pub. Date: Dec. 3, 2020

(54) METHOD OF MULTI-LINK RETRANSMISSION UNDER MULTIPLE CONNECTIONS, BASE STATION AND STORAGE MEDIUM

(71) Applicants: CHINA MOBILE COMMUNICATIONS GROUP CO., LTD RESEARCH INSTITUTE, Beijing (CN); CHINA MOBILE COMMUNICATIONS GROUP CO., LTD., Beijing (CN)

(72) Inventors: Gang LI, Beijing (CN); Liang LIU, Beijing (CN); Yami CHEN, Beijing (CN); Ba JIN, Beijing (CN); Junshuai SUN, Beijing (CN)

(21) Appl. No.: 16/497,227

(22) PCT Filed: Mar. 23, 2018
(86) PCT No.: PCT/CN2018/080365

§ 371 Date: Sep. 24, 2019

(30) Foreign Application Priority Data
Mar. 24, 2017 (CN) 201710184917.5

(51) Int. Cl. H04L 1/16; H04L 1/18; H04W 76/15; H04W 28/04

(52) U.S. Cl. CPC H04L 1/1685; H04L 1/1825; H04L 1/1858; H04L 2001/0093; H04W 76/15; H04W 28/04; H04L 1/1896

(57) ABSTRACT

Disclosed are a method of multi-link retransmission under multiple connections, base station and storage medium. The method comprises: connecting to at least two links at a terminal; when a transmission of data packets of the terminal fails on one link, a second network element reporting a status report; and when the first network element analyzes the status report and ascertains that the transmission of the data packets of the first link has failed, selecting another link for data retransmission.

### CROSS-REFERENCE TO RELATED APPLICATIONS

The present disclosure is a National Stage of International Patent Application No. PCT/CN2018/080365, filed Mar. 23, 2018 which is based upon and claims priority to Chinese Patent Application No. 201710184917.5, filed on Mar. 24, 2017, the contents of which are hereby incorporated by reference in their entirety.

### TECHNICAL FIELD

The disclosure relates to a retransmission technology, and more particularly to a method and a base station for implementing multilink retransmission in the case of multiple connections, and a storage medium.

### BACKGROUND

How to design a flexible and robust access network architecture is the key of a mobile communication system. In a 3rd-Generation (3G) system, logical nodes of an access network include a Node B (NB) and a Radio Network Controller (RNC). A 4th-Generation (4G) logical architecture is designed to be more flat, and only includes an Evolved Node B (eNB). Considering a requirement on a 5th-Generation (5G) access network architecture, the most typical requirement unlike that on a 4G access network is that the access network supports a logical function division of the access network into a Remote Unit (RU) and a Central Unit (CU), and supports migration of a protocol stack function between the CU and a Distributed Unit (DU). Compared with a flat 4G architecture, a CU-DU two-stage access network architecture has the advantages that: an inter-cell cooperation gain may be obtained, and centralized load management may be implemented; a centralized control in the case of dense networking, for example, multiple connections and high-density switching, may be efficiently implemented; and a pooling gain may be obtained, a Network Function Virtualization (NFV)/Software-Defined Networking (SDN) may be enabled, and deployment requirements of an operator on some 5G scenarios are met.

In a CU-DU two-stage architecture, two network elements (a CU and a DU) are located on a base station side. The CU is a central node capable of controlling and coordinating multiple cells, including protocol stack high-layer control and data functions, and possibly part of baseband processing functions. The DU is a distributed unit that realizes a Remote Radio Head (RRH) function and other baseband processing functions. The CU is connected with the DU through a fronthaul interface. There is only a Packet Data Convergence Protocol (PDCP) stack on the CU and a PDCP layer has no retransmission function. Therefore, in a scenario where retransmission is required, if a terminal fails to transmit on a link when the terminal accesses multiple DUs, how to implement fast retransmission on another link is a problem that is required to be solved in the CU-DU access network architecture.

### SUMMARY

In view of this, embodiments of the disclosure are intended to provide a method and a base station for implementing multilink retransmission in the case of multiple connections and a storage medium, which at least solve the problem in the related art.

The technical solutions in the embodiments of the disclosure are implemented as follows.

An embodiment of the disclosure provides a method for implementing multilink retransmission in the case of multiple connections, which includes the following operations.

A terminal accesses at least two links.

When the terminal fails to transmit a data packet on one link, a second network element reports a status report.

When the status report is analyzed to be that the data packet fails to be transmitted on a first link, a first network element selects other links for data retransmission.

In the solution, the method may further include the following operation.

The first network element allocates multiple data packets obtained by splitting to the at least two links.

In the solution, the method may further include the following operation.

After the multiple data packets are fragmented, the second network element provides multiple fragmented data packets to the terminal for transmission.

In the solution, the operation that the first network element selects the other links for data retransmission when the status report is analyzed to be that the data packet fails to be transmitted on the first link may include the following operation.

i links of which link transmission quality is higher than that of the first link are selected from the at least two links, and the data packet transmitted on the first link is retransmitted on the i links, i being a positive integer more than or equal to 1.

In the solution, the first network element may select the other links for data retransmission when the status report is analyzed to be that the data packet fails to be transmitted on the first link.

When the status report is analyzed to be that an xth fragmented data packet in the data packet fails to be transmitted on the first link, the first network element may select the other links for data retransmission.

In the solution, the method may further include the following operations.

The first network element selects i links of which link transmission quality is higher than that of the first link from the at least two links, x being a positive integer more than or equal to 1.

The first network element forwards an identifier of the first link obtained from the status report to the i links and retransmits the xth fragmented data packet transmitted on the first link on the i links according to the identifier of the first link, i being a positive integer more than or equal to 1.

An embodiment of the disclosure provides a base station, which includes a first network element and a second network element.

The first network element is configured to receive, in the case that a terminal access at least two links, a status report reported by the second network element when the terminal fails to transmit a data packet on one link and, when the status report is analyzed to be that the data packet fails to be transmitted on a first link, select other links for data retransmission.

The second network element is configured to report the status report and interact with the first network element to implement data packet retransmission in the case of multiple connections for the terminal.

In the solution, the first network element may further be configured to allocate multiple data packets obtained by splitting to the at least two links.

In the solution, the second network element may further be configured to, after the multiple data packets are fragmented, provide multiple fragmented data packets to the terminal for transmission.

In the solution, the first network element may further be configured to select i links of which link transmission quality is higher than that of the first link from the at least two links and retransmit the data packet transmitted on the first link on the i links, i being a positive integer more than or equal to 1.

In the solution, the first network element may further be configured to, when the status report is analyzed to be that an xth fragmented data packet in the data packet fails to be transmitted on the first link, select the other links for data retransmission.

In the solution, the first network element may further be configured to: select i links of which link transmission quality is higher than that of the first link from the at least two links, x being a positive integer more than or equal to 1, forward an identifier of the first link obtained from the status report to the i links, and retransmit the xth fragmented data packet transmitted on the first link on the i links according to the identifier of the first link, i being a positive integer more than or equal to 1.

An embodiment of the disclosure provides a method for implementing multilink retransmission in the case of multiple connections, which includes the following operations.

A terminal accesses at least two links.

When the terminal fails to transmit a data packet on one link, a first network element receives a status report reported by a second network element.

When the status report is analyzed to be that the data packet fails to be transmitted on a first link, the first network element selects other links for data retransmission.

In the solution, the method may further include the following operation.

The first network element allocates multiple data packets obtained by splitting to the at least two links.

An embodiment of the disclosure provides a base station, which includes a processor and a memory configured to store a computer program capable of running in the processor.

The processor is configured to run the computer program to execute the method in any of the abovementioned solution.

An embodiment of the disclosure provides a storage medium, in which a computer program is stored, the computer program being executed by a processor to implement the method in any of the abovementioned solution.

According to the embodiments of the disclosure, a solution for implementing multilink retransmission in the case of multiple connections includes the following operations. When a terminal accesses at least two links, multiple data packets obtained by splitting are allocated to the at least two links. When the terminal fails to transmit a data packet on one link, a first network element interacts with a second network element according to a preset strategy to implement data packet retransmission in the case of multiple connections for the terminal.

With the embodiments of the disclosure, the terminal accesses the at least two links; when the terminal fails to transmit the data packet on one link, the second network element reports the status report; and when the status report is analyzed to be that the data packet fails to be transmitted on the first link, the first network element selects the other links for data retransmission. When the terminal fails to transmit a data packet on one link in multiple links, the data packet that fails to be transmitted may be retransmitted quickly on another link, so that data packet retransmission in the case of multiple connections for the terminal may be implemented. The method is applied to a retransmission processing in a CU-DU access network architecture where a first network element is a CU and a second network element is a DU, and is not limited to a scenario of the CU-DU architecture.

### BRIEF DESCRIPTION OF DRAWINGS

FIG. 1 is a flowchart of implementing a method according to an embodiment of the disclosure.

FIG. 2 is a schematic diagram of a CU-DU architecture according to an embodiment of the disclosure.

FIG. 3 is a flowchart of implementing an application scenario according to an embodiment of the disclosure.

FIG. 4 is a flowchart of implementing an application scenario according to an embodiment of the disclosure.

FIG. 5 is a flowchart of implementing an application scenario according to an embodiment of the disclosure.

FIG. 6 is a flowchart of implementing an application scenario according to an embodiment of the disclosure.

FIG. 7 is a flowchart of implementing an application scenario according to an embodiment of the disclosure.

FIG. 8 is a flowchart of implementing an application scenario according to an embodiment of the disclosure.

FIG. 9 is a flowchart of implementing an application scenario according to an embodiment of the disclosure.

### DETAILED DESCRIPTION

Implementations of the technical solution will be further described in detail below with reference to the accompanying drawings.

### First Embodiment

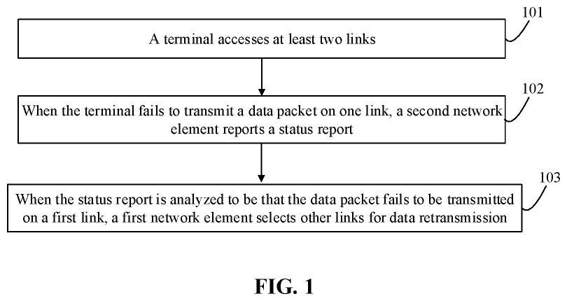

The embodiment of the disclosure provides a method for implementing multilink retransmission in the case of multiple connections. As shown in FIG. 1, the method includes the following steps.

At 101, a terminal accesses at least two links.

At 102, when the terminal fails to transmit a data packet on one link, a second network element reports a status report.

At 103, when the status report is analyzed to be that the data packet fails to be transmitted on a first link, a first network element selects other links for data retransmission.

During a practical application, when the terminal accesses at least two links, the first network element allocates multiple data packets obtained by splitting to the at least two links. Then, when the terminal fails to transmit the data packet on one link, the first network element receives the status report reported by the second network element through interaction between the first network element and the second network element. When the status report is analyzed by the first network element to be that the data packet fails to be transmitted on the first link, the first network element selects the other link for data retransmission, thereby implementing data packet retransmission in the case of multiple connections for the terminal.

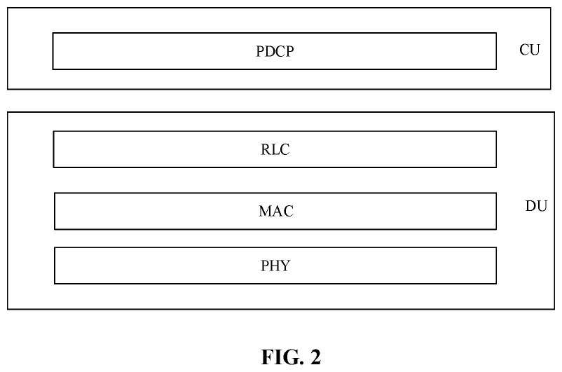

During the practical application, for example, the first network element is a CU on a base station side, and the second network element is a DU on the base station side. A CU-DU architecture is shown in FIG. 2. The CU splits the data packets according to multiple links accessed by the terminal, and in such case, the data packet refers to an Internet Protocol (IP) data packet or a compressed IP data packet. Unlike a subsequent fragmented data packet (or called a sharded data packet), called a “small packet”, obtained by fragmentation processing in the DU, the IP data packet or the compressed IP data packet may be called a “large packet”. All “small packets” and “large packets” mentioned herein are defined like this, just for simplifying the description. The DU performs fragmentation processing on the data packet to obtain fragmented data packets and then provides them to the corresponding links in the multiple links for transmission. If retransmission is required in such a multi-connection scenario, namely the terminal fails to transmit on one of the multiple links, signaling interaction between the CU and the DU is performed based on the architecture shown in FIG. 2 according to a preset strategy, and fast retransmission of the data packet that fails to be transmitted is implemented on the other link in the multiple links of the terminal, thereby implementing data packet retransmission in the case of multiple connections for the terminal. The embodiment of the disclosure is applied to a retransmission processing in a CU-DU access network architecture where the first network element is a CU and the second network element is a DU, and is not limited to a scenario of the CU-DU architecture.

As shown in FIG. 2, the CU is a central node capable of controlling and coordinating multiple cells, including protocol stack high-layer control and data functions, and possibly part of baseband processing functions. A unit in the CU is PDCP, and PDCP is configured for processing such as compression, encryption, re-assembling and splitting. The DU is a distributed unit that realizes an RRH function and other baseband processing functions. Units in the DU include: 1) Radio Link Control (RLC), RLC being configured for fragmentation, retransmission and the like; 2) Media Access Control (MAC), MAC being configured for scheduling, concatenation, multiplexing, retransmission and the like; and 3) Physical (PHY), PHY being configured for modulation, coding and the like. The CU is connected with the DU through a fronthaul interface.

There are multiple segmentation solutions for function division of CU-DU. Different segmentation solutions correspond to different application scenarios and performance gains, and also have greatly different requirements on parameters such as a bandwidth of the fronthaul interface, a transmission delay and synchronization. PDCP-RLC is a high-layer segmentation solution. The PDCP-RLC segmentation solution is most feasible for the CU-DU architecture in a future 3rd Generation Partnership Project (3GPP). Considering that there is only a PDCP stack on the CU and a PDCP layer has no retransmission function, if a terminal fails to transmit on a link when the terminal accesses multiple DUs, fast retransmission is required to be implemented on the other links. With the embodiments of the disclosure, fast retransmission in a multi-connection scenario is implemented through specific implementation of interaction between CU-DU in each subsequent embodiment.

### Second Embodiment

Based on the abovementioned embodiment, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The first network element, for example, the CU, triggers retransmission, and the first network element, for example, the CU, executes retransmission. Specifically, when the first network element receives a status report reported by the terminal, the first network element triggers retransmission. When the status report is analyzed to be that a data packet fails to be transmitted on a first link, the first network element selects, from the at least two links, i links of which link transmission quality is higher than that of the first link and retransmits the data packet transmitted on the first link on the i links, i being a positive integer more than or equal to 1.

In an implementation of the embodiment of the disclosure, there are two reporting manners for the status report, including: 1) active reporting, namely the terminal periodically reports the status report; and 2) passive reporting, namely the terminal reports the status report after receiving a query request from the first network element. During a practical application, a PDCP status report is reported based on a network configuration, for example, reported by the terminal responsive to active query from an base station (passive reporting) or periodically reported by the terminal (active reporting).

### Third Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The second network element, for example, the DU, triggers the retransmission, and the first network element, for example, the CU, executes the retransmission. Specifically, when the second network element finds that a data packet fails to be transmitted on a first link and/or the first link is abnormal, the second network element triggers the retransmission. The second network element reports a status report. When the status report is analyzed by the first network element to be that the data packet fails to be transmitted on the first link, the first network element selects, from the at least two links, i links of which link transmission quality is higher than that of the first link and retransmits the data packet transmitted on the first link on the i links, i being a positive integer more than or equal to 1.

### Fourth Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The second network element, for example, the DU, triggers the retransmission, and the first network element, for example, the CU, executes the retransmission. Specifically, when the second network element finds that a data packet fails to be transmitted on a first link and/or the first link is abnormal, the second network element triggers the retransmission. The second network element reports a status report. When the status report is analyzed by the first network element to be that the data packet fails to be transmitted on the first link, the first network element initiates a query request to the terminal to confirm a transmission status. The first network element receives a query response fed back by the terminal, analyzes from the query response that the transmission status is that the data packet fails to be transmitted on the first link, selects, from the at least two links, i links of which link transmission quality is higher than that the first link, and retransmits the data packet transmitted on the first link on the i links, i being a positive integer more than or equal to 1.

Unlike the third embodiment, the first network element is required to confirm the transmission status from the terminal. During a practical application, considering that the terminal may have received a packet with PDCP SN=n2 from the CU, but an Acknowledgement (ACK) may fail to be transmitted on a radio link, the CU may initiate a request of querying a PDCP transmission status to the terminal to determine a PDCP data packet that needs to be retransmitted. SN denotes a sequence number and will not be elaborated.

### Fifth Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The first network element, for example, the CU, triggers the retransmission, and the first network element, for example, the CU, executes the retransmission. In the abovementioned embodiments, complete retransmission is involved, namely the data packet, or called a “large packet”, is transmitted. Unlike the abovementioned embodiments, in the embodiment of the disclosure, partial retransmission is involved, and a fragmented data packet, or called a “small packet”, is transmitted, namely only the “small packet” that fails to be transmitted is transmitted, complete retransmission is not required, and fragmented data packets are required to be re-assembled after successful transmission. Specifically, when the first network element receives a status report reported by the terminal, the first network element triggers the retransmission. When the status report is analyzed to be that a data packet fails to be transmitted on a first link, the first network element initiates a query request to the second network element to confirm a transmission status. The first network element receives a query response fed back by the second network element and analyzes from the query response that the transmission status is that an xth fragmented data packet in the data packet fails to be transmitted on the first link, x being a positive integer more than or equal to 1. The first network element selects i links of which link transmission quality is higher than that of the first link from the at least two links, forwards an identifier of the first link obtained from the query response to the i links, and retransmits the xth fragmented data packet transmitted on the first link on the i links according to the identifier of the first link, such that the fragmented data packets are re-assembled at the terminal, i being a positive integer more than or equal to 1.

In an implementation of the embodiment of the disclosure, the second network element (for example, the DU) sends the status report to the first network element (for example, the CU), the status report including a starting position of the data packet that fails to be transmitted and the like. Therefore, not only information about the fragmented data packets of the first network element is backed up to the second network element, but also the identifier of the link on which the data packet fails to be transmitted is contained, so as to facilitate the first network element to perform subsequent retransmission processing on a better link. During a practical application, a unit “link 1-RLC” in the second network element (for example, the DU) may also return a transmission status report of a PDCP Protocol Data Unit (PDU) (including an initial status of an RLC PDU that fails to be transmitted), and a unit “PDCP” in the first network element (for example, the CU), after receiving the transmission report, generates the RLC PDU containing an identifier of the link 1, and selects a better link 2 for transmission.

### Sixth Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The second network element, for example, the DU, triggers the retransmission, and the first network element, for example, the CU, executes the retransmission. In the abovementioned embodiments, complete retransmission is involved, namely the data packet, or called a “large packet”, is transmitted. Unlike the abovementioned embodiments, in the embodiment of the disclosure, partial retransmission is involved, and a fragmented data packet, or called a “small packet”, is transmitted, namely only the “small packet” that fails to be transmitted is retransmitted, complete retransmission is not required, and fragmented data packets are required to be re-assembled after successful transmission. Specifically, when the second network element finds that a data packet fails to be transmitted on a first link and/or the first link is abnormal, the second network element triggers the retransmission. The second network element reports a status report. When the status report is analyzed to be that an xth fragmented data packet in the data packet fails to be transmitted on the first link, the first network element selects, from the at least two links, i links of which link transmission quality is higher than that of the first link, x being a positive integer more than or equal to 1. The first network element forwards an identifier of the first link obtained from the status report to the i links and retransmits the xth fragmented data packet transmitted on the first link on the i links according to the identifier of the first link, such that the fragmented data packets are re-assembled at the terminal, i being a positive integer more than or equal to 1.

In an implementation of the embodiment of the disclosure, the second network element (for example, the DU) sends the status report to the first network element (for example, the CU), the status report including a starting position of the data packet that fails to be transmitted and the like. Therefore, not only information about the fragmented data packets of the first network element is backed up to the second network element, but also the identifier of the link on which the data packet fails to be transmitted is contained, so as to facilitate the second network element to perform subsequent retransmission processing on a better link. During a practical application, a unit “link 1-RLC” in the second network element (for example, the DU) may also return a transmission status report of a PDCP Protocol Data Unit (PDU) (including an initial status of an RLC PDU that fails to be transmitted), and a unit “PDCP” in the first network element (for example, the CU), after receiving the transmission report, generates the RLC PDU containing an identifier of the link 1 and selects a better link 2 for transmission.

### Seventh Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The second network element, for example, the DU, triggers the retransmission, and the first network element, for example, the CU, executes the retransmission. In the abovementioned embodiments, complete retransmission is involved, namely the data packet, or called a “large packet”, is transmitted. Unlike the abovementioned embodiments, in the embodiment of the disclosure, partial retransmission is involved, and a fragmented data packet, or called a “small packet”, is transmitted, namely only the “small packet” that fails to be transmitted is retransmitted, complete retransmission is not required, processing is required according to a query response fed back by the terminal, and fragmented data packets are required to be re-assembled after successful transmission. Specifically, when the second network element finds that a data packet fails to be transmitted on a first link and/or the first link is abnormal, the second network element triggers the retransmission. The second network element reports a status report. When the status report is analyzed to be that an xth fragmented data packet in the data packet fails to be transmitted on the first link, the first network element initiates a query request to the terminal to confirm a transmission status. The first network element receives the query response fed back by the terminal, analyzes from the query response that the transmission status is that the xth fragmented data packet in the data packet fails to be transmitted on the first link, and selects i links of which link transmission quality is higher than that of the first link from the at least two links, x being a positive integer more than or equal to 1. The first network element forwards an identifier of the first link obtained from the query response to the i links, and retransmits the xth fragmented data packet transmitted on the first link on the i links according to the identifier of the first link, such that the fragmented data packets are re-assembled at the terminal, i being a positive integer more than or equal to 1.

In the embodiment of the disclosure, the first network element is required to confirm the specific fragmented data packet that fails to be transmitted according to the transmission status fed back by the terminal. During a practical application, considering that the terminal may have received a packet PDCP SN=n2 from the CU but an ACK may fail to be transmitted on a radio link, the CU may initiate a request of querying a PDCP transmission status to the terminal to determine a PDCP data packet that needs to be retransmitted.

### Eighth Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of multi-transmission and multi-reception in a multi-connection scenario is described, namely the terminal simultaneously accesses at least two links at present and performs concurrent processing on the at least two links without link switching. The second network element, for example, the DU, triggers the retransmission, and the first network element, for example, the CU, executes the retransmission.

When the second network element finds that a data packet fails to be transmitted on a first link and/or the first link is abnormal, the second network element triggers the retransmission. The second network element reports a status report. Meanwhile, the terminal also reports a status report. The two status reports may be the same or may be different. The first network element analyzes the two status reports to obtain a practical transmission status (mainly subjected to a transmission status in the status report reported by the terminal) by comparison. When the practical transmission status is that the data packet fails to be transmitted on a first link, the first network element selects i links of which link transmission quality is higher than that of the first link from the at least two links, and retransmits the data packet transmitted on the first link on the i links, i being a positive integer more than or equal to 1. When the practical transmission status is that the data packet fails to be transmitted on the first link and an xth fragmented data packet in the data packet fails to be transmitted on the first link, x being a positive integer more than or equal to 1, the first network element selects the i links of which the link transmission quality is higher than that of the first link from the at least two links, forwards an identifier of the first link obtained from the status report to the i links, and retransmits the xth fragmented data packet transmitted on the first link on the i links according to the identifier of the first link, such that the fragmented data packets are re-assembled at the terminal, i being a positive integer more than or equal to 1.

### Ninth Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of single-transmission and single-reception in a multi-connection scenario is described, namely the terminal accesses one of at least two links at present and switching among the at least two links is required. The first network element, for example, the CU, triggers the retransmission, and the first network element, for example, the CU, executes the retransmission. The difference from the abovementioned embodiments is that the case of multi-transmission and multi-reception in the multi-connection scenario is described in the abovementioned embodiments. In the present embodiment, two manners are involved. One manner is similar to a complete retransmission strategy in the case of multi-transmission and multi-reception, namely a data packet, or called a “large packet”, is transmitted. The other manner is similar to a partial retransmission strategy in the case of multi-transmission and multi-reception, namely a fragmented data packet, or called a “small packet” is transmitted. Only the “small packet” that fails to be transmitted is transmitted and complete retransmission is not required. Furthermore, processing may be performed according to a query response fed back by the terminal, and fragmented data packets are required to be re-assembled after successful transmission. In the embodiment of the disclosure, for example, for the partial retransmission strategy, the first network element, after an inter-link switching occurs on the at least two links accessed by the terminal, receives a status report reported by the terminal, and the first network element triggers the retransmission. The first network element analyzes that the status report is that a data packet fails to be transmitted on a first link, and initiates a query request to the second network element to confirm a transmission status, namely which fragmented data packet in the data packet fails to be transmitted on the first link. The first network element receives a query response fed back by the second network element and analyzes from the query response that an xth fragmented data packet in the data packet fails to be transmitted on the first link, x being a positive integer more than or equal to 1. The first network element selects i links of which link transmission quality is higher than that of the first link from the at least two links, forwards an identifier of the first link obtained from the query response to the i links, and retransmits the xth fragmented data packet transmitted on the first link on the i links according to the identifier of the first link, such that the fragmented data packets are re-assembled at the terminal, i being a positive integer more than or equal to 1.

### Tenth Embodiment

Based on the abovementioned embodiments, in the embodiment of the disclosure, fast retransmission of the data packet in the case of multiple connections for the terminal is implemented through interaction between a first network element and a second network element. The embodiment of the disclosure is applied to a retransmission processing in a CU-DU access network architecture where a first network element is a CU and a second network element is a DU, and is not limited to a scenario of the CU-DU architecture.

In the embodiment of the disclosure, the case of single-transmission and single-reception in a multi-connection scenario is described, namely the terminal accesses one of at least two links at present and switching among the at least two links is required. The second network element, for example, the DU, triggers retransmission, and the first network element, for example, the CU, executes the retransmission. The difference from the abovementioned embodiments is that the case of multi-transmission and multi-reception in the multi-connection scenario is described in the abovementioned embodiments. In the present embodiment, two manners are involved. One manner is similar to a complete retransmission strategy in the case of multi-transmission and multi-reception, namely a data packet, or called a “large packet”, is transmitted. The other manner is similar to a partial retransmission strategy in the case of multi-transmission and multi-reception, namely a fragmented data packet, or called a “small packet” is transmitted. Only the “small packet” that fails to be transmitted is transmitted and complete retransmission is not required. Furthermore, processing may be performed according to a query response fed back by the terminal, and fragmented data packets are required to be re-assembled after successful transmission. In the embodiment of the disclosure, for example, for the partial retransmission strategy, when the second network element, after an inter-link switching occurs on the at least two links accessed by the terminal, finds that a data packet fails to be transmitted on a first link and/or the first link is abnormal, the second network element triggers the retransmission. The second network element reports a status report. When the status report is analyzed to be that an xth fragmented data packet in the data packet fails to be transmitted on the first link, the first network element selects i links of which link transmission quality is higher than that of the first link from the at least two links, x being a positive integer more than or equal to 1. The first network element forwards an identifier of the first link obtained from the status report to the i links, and retransmits the xth fragmented data packet transmitted on the first link on the i links according to the identifier of the first link, such that the fragmented data packets are re-assembled at the terminal, i being a positive integer more than or equal to 1.

### Eleventh Embodiment

The embodiment of the disclosure provides a base station, which includes a first network element and a second network element. The first network element is configured to receive a status report reported by the second network element when a terminal accesses at least two links and fails to transmit a data packet on one link and, when the status report is analyzed to be that the data packet fails to be transmitted on a first link, select other links for data retransmission. The second network element is configured to report the status report and interact with the first network element to implement fast retransmission of the data packet in the case of multiple connections for the terminal.

In the embodiment of the disclosure, when the terminal accesses the at least two links, the first network element allocates multiple data packets obtained by splitting to the at least two links; and then, when the terminal fails to transmit the data packet on one link, the first network element interacts with the second network element to implement retransmission of the data packet in the case of multiple connections for the terminal.

During a practical application, for example, the first network element is a CU on a base station side, and the second network element is a DU on the base station side. A CU-DU architecture is shown in FIG. 2. The CU splits the data packets according to multiple links accessed by the terminal, and in such case, the data packet refers to an IP data packet or a compressed IP data packet. Unlike a subsequent fragmented data packet (or called a sharded data packet), called a “small packet”, obtained by fragmentation processing in the DU, the IP data packet or the compressed IP data packet may be called a “large packet”. All “small packets” and “large packets” mentioned herein are defined like this, just for simplifying the description. The DU performs fragmentation processing on the data packet to obtain fragmented data packets and then provides them to the corresponding links in the multiple links for transmission. If retransmission is required in such a multi-connection scenario, namely the terminal fails to transmit on one of the multiple links, signaling interaction between the CU and the DU is performed based on the architecture shown in FIG. 2 according to a preset strategy, and fast retransmission of the data packet that fails to be transmitted is implemented on the other link in the multiple links of the terminal, thereby implementing data packet retransmission in the case of multiple connections for the terminal. The embodiment of the disclosure is applied to a retransmission processing in a CU-DU access network architecture where a first network element is a CU and a second network element is a DU, and is not limited to a scenario of the CU-DU architecture.

As shown in FIG. 2, the CU is a central node capable of controlling and coordinating multiple cells, including protocol stack high-layer control and data functions, and possibly part of baseband processing functions. A unit in the CU is PDCP, and PDCP is configured for processing such as compression, encryption, re-assembling and splitting. The DU is a distributed unit that realizes an RRH function and other baseband processing functions. Units in the DU include: 1) RLC, RLC being configured for fragmentation, retransmission and the like; 2) MAC, MAC being configured for scheduling, concatenation, multiplexing, retransmission and the like; and 3) PHY, PHY being configured for modulation, coding and the like. The CU is connected with the DU through a fronthaul interface.

There are multiple segmentation solutions for function division of CU-DU. Different segmentation solutions correspond to different application scenarios and performance gains, and also have greatly different requirements on parameters such as a bandwidth of the fronthaul interface, a transmission delay and synchronization. PDCP-RLC is a high-layer segmentation solution. The PDCP-RLC segmentation solution is most feasible for the CU-DU architecture in a future 3rd Generation Partnership Project (3GPP). Considering that there is only a PDCP stack on the CU and a PDCP layer has no retransmission function, if a terminal fails to transmit on a link when the terminal accesses multiple DUs, fast retransmission is required to be implemented on the other links. With the embodiment of the disclosure, fast retransmission in a multi-connection scenario is implemented through specific implementation of interaction between CU-DU in each subsequent embodiment.

In an implementation of the embodiment of the disclosure, the first network element is further configured to: when the first network element receives the status report, trigger a retransmission; and when the status report is analyzed to be that the data packet fails to be transmitted on a first link, select i links of which link transmission quality is higher than that of the first link from the at least two links and retransmit the data packet transmitted on the first link on the i links, i being a positive integer more than or equal to 1. A reporting manner for the status report includes that: 1) the terminal periodically reports the status report; and 2) the terminal reports the status report after receiving a query request from the first network element.

In an implementation of the embodiment of the disclosure, the first network element is further configured to: when the first network element receives a status report reported by the terminal, trigger a retransmission; and when the status report is analyzed to be that the data packet fails to be transmitted on the first link, select i links of which the link transmission quality is higher than that of the first link from the at least two links and retransmit the data packet transmitted on the first link on the i links, i being a positive integer more than or equal to 1.

In an implementation of the embodiment of the disclosure, the status report includes: a status report periodically reported by the terminal; or a status report reported by the terminal after receiving a query request from the first network element.

In an implementation of the embodiment of the disclosure, the second network element is further configured to: when the second network element finds that the data packet fails to be transmitted on the first link and/or the first link is abnormal, trigger the retransmission; and report the status report.

The first network element is further configured to: when the status report is analyzed to be that the data packet fails to be transmitted on the first link, select i links of which the link transmission quality is higher than that of the first link from the at least two links and retransmit the data packet transmitted on the first link on the i links, i being a positive integer more than or equal to 1.

In an implementation of the embodiment of the disclosure, the second network element is further configured to: when the second network element finds that the data packet fails to be transmitted on the first link and/or the first link is abnormal, trigger the retransmission; and report the status report.

The first network element is further configured to: when the status report is analyzed to be that the data packet fails to be transmitted on the first link and/or the first link is abnormal, initiate a query request to the terminal to confirm a transmission status; and receive a query response fed back by the terminal, analyze that the transmission status is that the data packet fails to be transmitted on the first link, select i links of which the link transmission quality is higher than that of the first link from the at least two links and retransmit the data packet transmitted on the first link on the i links, i being a positive integer more than or equal to 1.

In an implementation of the embodiment of the disclosure, the first network element is further configured to: when the first network element receives the status report reported by the terminal, trigger the retransmission; when the status report is analyzed to be that the data packet fails to be transmitted on the first link, initiate a query request to the second network element to confirm a transmission status of which fragmented data packet in the data packet fails to be transmitted on the first link; receive a query response fed back by the second network element and analyze that the transmission status is that an xth fragmented data packet in the data packet fails to be transmitted on the first link, x being a positive integer more than or equal to 1; and select i links of which the link transmission quality is higher than that of the first link from the at least two links, forward an identifier of the first link obtained from the query response to the i links and retransmit the xth fragmented data packet transmitted on the first link on the i links according to the identifier of the first link, such that the fragmented data packets are re-assembled at the terminal, i being a positive integer more than or equal to 1.

In an implementation of the embodiment of the disclosure, the second network element is further configured to: when the second network element finds that the data packet fails to be transmitted on the first link and/or the first link is abnormal, trigger the retransmission; and report the status report.

The first network element is further configured to: when the status report is analyzed to be that the xth fragmented data packet in the data packet fails to be transmitted on the first link, select i links of which the link transmission quality is higher than that of the first link from the at least two links, x being a positive integer more than or equal to 1; and forward the identifier of the first link obtained from the status report to the i links, and retransmit the xth fragmented data packet transmitted on the first link on the i links according to the identifier of the first link, such that the fragmented data packets are re-assembled at the terminal, i being a positive integer more than or equal to 1.

In an implementation of the embodiment of the disclosure, the second network element is further configured to: when the second network element finds that the data packet fails to be transmitted on the first link and/or the first link is abnormal, trigger the retransmission; and report the status report.

The first network element is further configured to: when the status report is analyzed to be that the xth fragmented data packet in the data packet fails to be transmitted on the first link, initiate a query request to the terminal to confirm a transmission status; receive a query response fed back by the terminal, analyze that the transmission status is that the xth fragmented data packet in the data packet fails to be transmitted on the first link, and select i links of which the link transmission quality is higher than that of the first link from the at least two links, x being a positive integer more than or equal to 1; and forward an identifier of the first link obtained from the query response to the i links and retransmit the xth fragmented data packet transmitted on the first link on the i links according to the identifier of the first link, such that the fragmented data packets are re-assembled at the terminal, i being a positive integer more than or equal to 1.

In an implementation of the embodiment of the disclosure, the first network element is further configured to: after an inter-link switching occurs on at least two links accessed by the terminal, receive a status report reported by the terminal and trigger a retransmission; analyze that the status report is that a data packet fails to be transmitted on a first link, and initiate a query request to the second network element to confirm a transmission status; receive a query response fed back by the second network element, and analyze that the transmission status is that a xth fragmented data packet in the data packet fails to be transmitted on the first link, x being a positive integer more than or equal to 1; and select i links of which the link transmission quality is higher than that of the first link from the at least two links, forward an identifier of the first link obtained from the query response to the i links and retransmit the xth fragmented data packet transmitted on the first link on the i links according to the identifier of the first link, such that the fragmented data packets are re-assembled at the terminal, i being a positive integer more than or equal to 1.

In an implementation of the embodiment of the disclosure, the second network element is further configured to: when the second network element, after an inter-link switching occurs on at least two links accessed by the terminal, finds that the data packet fails to be transmitted on the first link and/or the first link is abnormal, trigger the retransmission; and report the status report.

The first network element is further configured to: when the status report is analyzed to be that the xth fragmented data packet in the data packet fails to be transmitted on the first link, select i links of which the link transmission quality is higher than that of the first link from the at least two links, x being a positive integer more than or equal to 1; and forward an identifier of the first link obtained from the status report to the i links and retransmit the xth fragmented data packet transmitted on the first link on the i links according to the identifier of the first link, such that the fragmented data packets are re-assembled at the terminal, i being a positive integer more than or equal to 1.

An embodiment of the disclosure provides a base station, which includes a processor and a memory configured to store a computer program capable of running in the processor.

The processor is configured to execute the steps of any of the methods in the abovementioned solution when running the computer program.

Specifically, the processor is configured to implement the following operations when running the computer program.

A terminal accesses at least two links.

When the terminal fails to transmit a data packet on one link, a second network element reports a status report.

When the status report is analyzed to be that the data packet fails to be transmitted on a first link, the first network element selects other links for data retransmission.

The processor is further configured to implement the following operation when running the computer program.

After the multiple data packets are fragmented, the second network element provides the multiple fragmented data packets to the terminal for transmission.

The processor is further configured to implement the following operation when running the computer program.

i links of which link transmission quality is higher than that of the first link is selected from the at least two links, and the data packet transmitted on the first link is retransmitted on the i links, i being a positive integer more than or equal to 1.

The processor is further configured to implement the following operation when running the computer program.

When the status report is analyzed to be that an xth fragmented data packet in the data packet fails to be transmitted on the first link, the first network element selects the other link for data retransmission.

The processor is further configured to implement the following operations when running the computer program.

The first network element selects i links of which the link transmission quality is higher than that of the first link from the at least two links, x being a positive integer more than or equal to 1.

The first network element forwards an identifier of the first link obtained from the status report to the i links and retransmits the xth fragmented data packet transmitted on the first link on the i links according to the identifier of the first link, i being a positive integer more than or equal to 1.

An embodiment of the disclosure provides a storage medium, in which a computer program is stored, the computer program being executed by a processor to implement the steps of any of the methods in the abovementioned solution.

Specifically, the computer program is executed by the processor to implement the following operations.

A terminal accesses at least two links.

When the terminal fails to transmit a data packet on one link, a second network element reports a status report.

When the status report is analyzed to be that the data packet fails to be transmitted on a first link, the first network element selects other links for data retransmission.

The computer program is executed by the processor to further implement the following operation.

After the multiple data packets are fragmented, the second network element provides the multiple fragmented data packets to the terminal for transmission.

The computer program is executed by the processor to further implement the following operation.

i links of which link transmission quality is higher than that of the first link are selected from the at least two links, and the data packet transmitted on the first link is retransmitted on the i links, i being a positive integer more than or equal to 1.

The computer program is executed by the processor to further implement the following operation.

When the status report is analyzed to be that an xth fragmented data packet in the data packet fails to be transmitted on the first link, the first network element selects other links for data retransmission.

The computer program is executed by the processor to further implement the following operations.

The first network element selects i links of which the link transmission quality is higher than that of the first link from the at least two links, i being a positive integer more than or equal to 1.

The first network element forwards an identifier of the first link obtained from the status report to the i links and retransmits the xth fragmented data packet transmitted on the first link on the i links according to the identifier of the first link, i being a positive integer more than or equal to 1.

The embodiments of the disclosure will be elaborated below with a practical application scenario as an example.

The following specific solutions may be adopted for application scenarios of the embodiments of the disclosure, and will be elaborated below respectively.

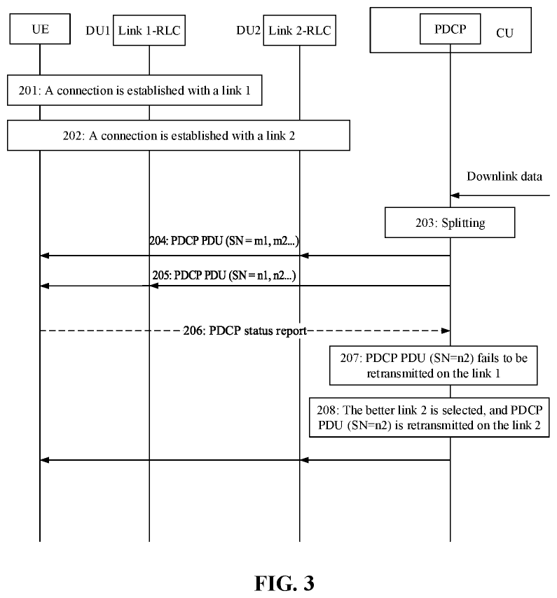

Solution 1: a PDCP layer triggers retransmission of a PDCP packet among different link legs, as shown in FIG. 3.

A flow shown in FIG. 3 includes the following operations.

At 201, a connection is established with a link 1.

At 202, a connection is established with a link 2.

At 203, downlink data is split.

At 204, data packets are transmitted, the data packets being PDCP PDU (SN=m1, m2 . . . ).

At 205, data packets are transmitted, the data packets being PDCP PDU (SN=n1, n2 . . .).

At 206, a PDCP status report is reported.

At 207, it is found that transmission on a link fails, for example, the PDCP PDU (SN=n2) fails to be transmitted on the link 1.

At 208, the better link 2 is selected, the PDCP PDU (SN=n2) is retransmitted on the link 2, and subsequent signaling interaction is continued.

The embodiment of the disclosure may further include the following operation. The PDCP status report is reported based on a network configuration, for example, reported by a terminal responsive to active query from a base station or periodically reported by the terminal.

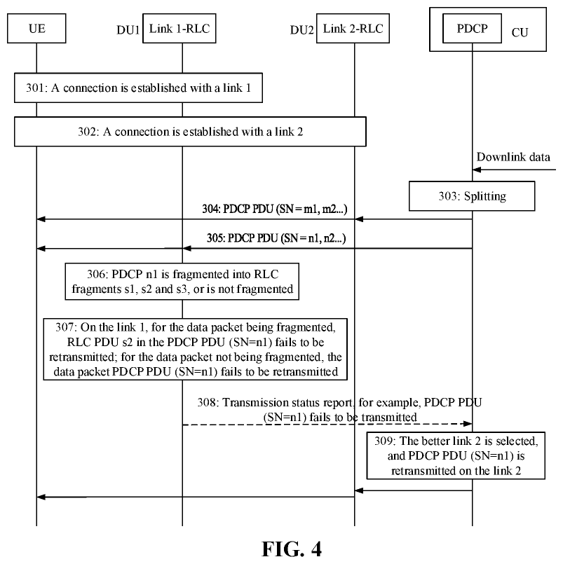

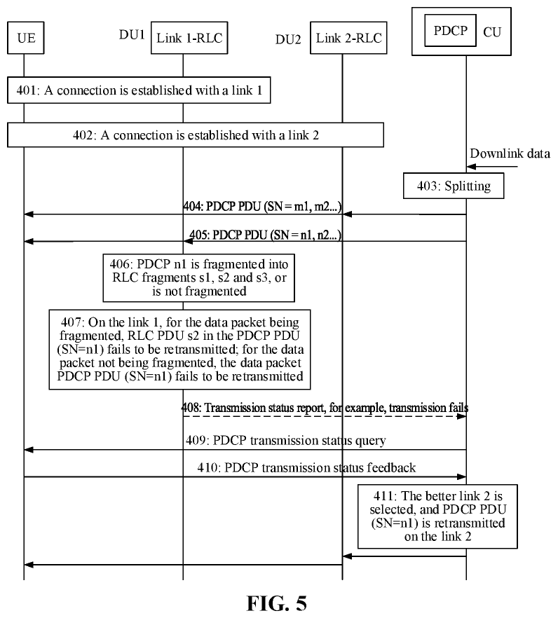

Solution 2: RLC triggers retransmission of a PDCP packet among different legs, as shown in FIG. 4-FIG. 5.

A flow shown in FIG. 4 includes the following operations.

At 301, a connection is established with a link 1.

At 302, a connection is established with a link 2.

At 303, downlink data is split.

At 304, data packets are transmitted, the data packets being PDCP PDU (SN=m1, m2 . . . ).

At 305, data packets are transmitted, the data packets being PDCP PDU (SN=n1, n2 . . . ).

At 306, the PDCP n1 is fragmented into RLC fragments s1, s2 and s3, or is not fragmented.

At 307, transmission on a link fails, for example, if the data packet is fragmented, the RLC PDU s2 in the data packet PDCP PDU (SN=n1) fails to be transmitted on the link 1, or if not being fragmented, the data packet PDCP PDU (SN=n1) fails to be transmitted on the link 1.

At 308, a transmission status report is reported, for example, the PDCP PDU (SN=n1) fails to be transmitted.

At 309, the better link 2 is selected, the PDCP PDU (SN=n1) is retransmitted on the link 2, and subsequent signaling interaction is continued.

In FIG. 4, since a PDCP status report is not fed back by the terminal and RLC feeds back a status report to a PDCP layer, a delay is shorter. In addition, considering that the terminal may have received the packet PDCP SN=n2 but an ACK may fail to be transmitted on a radio link, a CU may also initiate a request of querying a PDCP transmission status to the terminal to determine the PDCP data packet to be retransmitted, as shown in FIG. 5.

A flow shown in FIG. 5 includes the following operations.

At 401, a connection is established with a link 1.

At 402, a connection is established with a link 2.

At 403, downlink data is split.

At 404, data packets are transmitted, the data packets being PDCP PDU (SN=m1, m2 . . . ).

At 405, data packets are transmitted, the data packets being PDCP PDU (SN=n1, n2 . . . ).

At 406, the PDCP n1 is fragmented into RLC fragments s1, s2 and s3, or is not fragmented.

At 407, transmission on a link fails, for example, if the data packet is fragmented, the RLC PDU s2 in the data packet PDCP PDU (SN=n1) fails to be transmitted on the link 1, or if not being fragmented, the data packet PDCP PDU (SN=n1) fails to be transmitted on the link 1.

At 408, a transmission status report is reported, for example, transmission fails.

At 409, a PDCP transmission status query is initiated.

At 410, a PDCP transmission status is reported.

At 411, the better link 2 is selected, the PDCP PDU (SN=n1) is retransmitted on the link 2, and subsequent signaling interaction is continued.

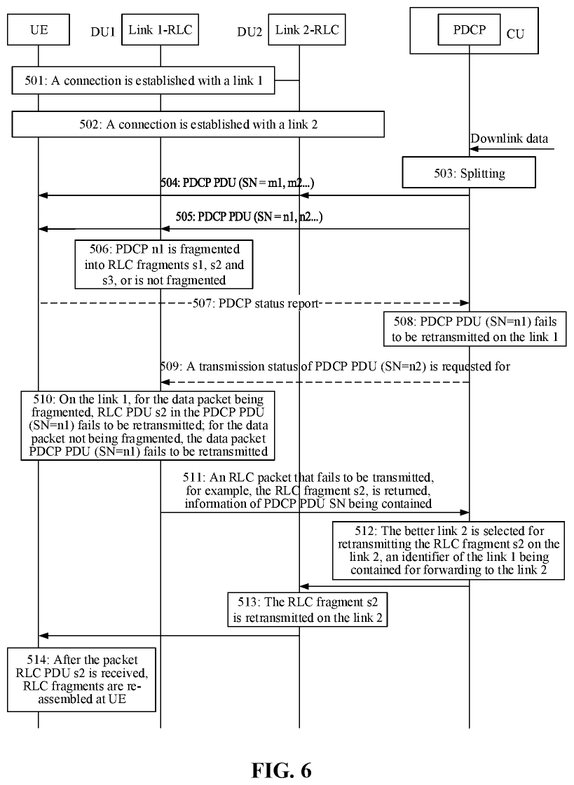

Solution 3: PDCP triggers retransmission of an RLC packet among different legs, as shown in FIG. 6.

A flow shown in FIG. 6 includes the following operations.

At 501, a connection is established with a link 1.

At 502, a connection is established with a link 2.

At 503, downlink data is split.

At 504, data packets are transmitted, the data packets being PDCP PDU (SN=m1, m2 . . . ).

At 505, data packets are transmitted, the data packets being PDCP PDU (SN=n1, n2 . . . ).

At 506, the PDCP n1 is fragmented into RLC fragments s1, s2 and s3, or is not fragmented.

At 507, a PDCP status report is reported.

At 508, transmission on a link fails, for example, the PDCP PDU (SN=n1) fails to be transmitted on the link 1.

At 509, a transmission status of the PDCP PDU (SN=n2) is requested for.

At 510, it is found that transmission on the link fails, for example, if the data packet is fragmented, the RLC PDU s2 in the data packet PDCP PDU (SN=n1) fails to be transmitted on the link 1, or if not being fragmented, the data packet PDCP PDU (SN=n1) fails to be transmitted on the link 1.

At 511, the RLC packet (for example, RLC fragment s2) that fails to be transmitted is returned, and information of PDCP PDU SN is contained.

At 512, the better link 2 is selected for retransmitting the RLC fragment s2 on the link 2, and an identifier of the link 1 is contained for forwarding to the link 2.

At 513, the RLC fragment s2 is retransmitted on the link 2.

At 514, after the packet RLC PDU s2 is received, RLC fragments are re-assembled at a terminal, and subsequent signaling interaction is continued.

In the embodiment of the disclosure, a PDCP PDU transmission status report (including an initial status of the RLC PDU that fails to be transmitted) may further be returned through link 1-RLC, and the PDCP, after receiving the transmission report, generates the RLC PDU containing the identifier of the link 1 and selects the better link 2 for transmission.

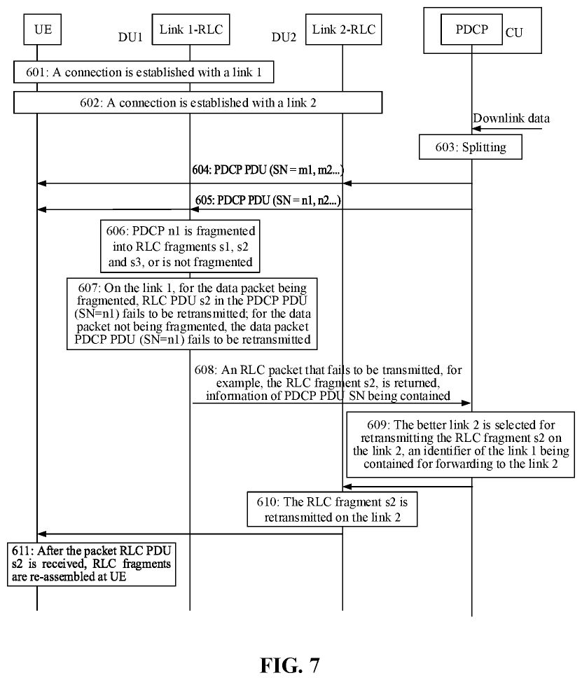

Solution 4: RLC triggers transmission of an RLC packet among different legs, as shown in FIG. 7.

A flow shown in FIG. 7 includes the following operations.

At 601, a connection is established with a link 1.

At 602, a connection is established with a link 2.

At 603, downlink data is split.

At 604, data packets are transmitted, the data packets being PDCP PDU (SN=m1, m2 . . . ).

At 605, data packets are transmitted, the data packets being PDCP PDU (SN=n1, n2 . . . ).

At 606, the PDCP n1 is fragmented into RLC fragments s1, s2 and s3, or is not fragmented.

At 607, transmission on a link fails, for example, if the data packet is fragmented, the RLC PDU s2 in the data packet PDCP PDU (SN=n1) fails to be transmitted on the link 1, or if not being fragmented, the data packet PDCP PDU (SN=n1) fails to be transmitted on the link 1.

At 608, the RLC packet (for example, RLC fragment s2) that fails to be transmitted is returned, and information of PDCP PDU SN is contained.

At 609, the better link 2 is selected for retransmitting the RLC fragment s2 on the link 2, and an identifier of the link 1 is contained for forwarding to the link 2.

At 610, the RLC fragment s2 is retransmitted on the link 2.

At 611, after the packet RLC PDU s2 is received, RLC fragments are re-assembled at a terminal, and subsequent signaling interaction is continued.

In the embodiment of the disclosure, a PDCP PDU transmission status report (including an initial status of the RLC PDU that fails to be transmitted) may be returned through link 1-RLC, and the PDCP, after receiving the transmission report, generates the RLC PDU containing the identifier of the link 1 and selects the better link 2 for transmission.

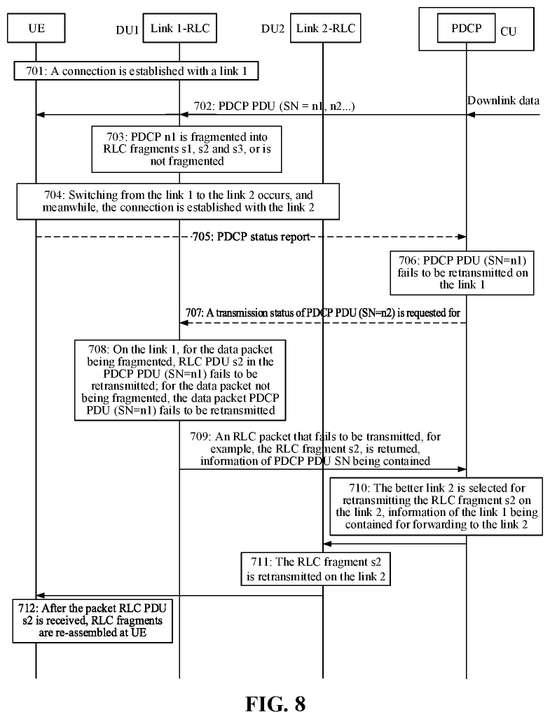

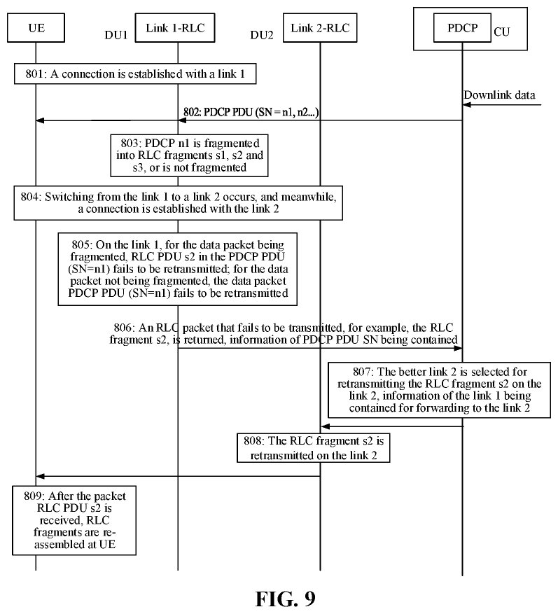

Solution 5: an RLC fragment packet may be retransmitted for a DU switching scenario, as shown in FIG. 8-FIG. 9. Unlike the abovementioned “dual-transmission and dual-reception scenario” in the multi-connection, Solution5 involves a “single-transmission and single-reception scenario” in the multi-connection.

FIG. 8 shows a flow of a retransmission triggered by PDCP, including the following operations.

At 701, a connection is established with a link 1.

At 702, downlink data packets PDCP PDU (SN=n1, n2 . . . ) are transmitted.

At 703, the PDCP n1 is fragmented into RLC fragments s1, s2 and s3, or is not fragmented.

At 704, switching from the link 1 to a link 2 occurs, and meanwhile, a connection is established with the link 2.

At 705, a PDCP status report is reported.

At 706, transmission on a link fails, for example, the PDCP PDU (SN=n1) fails to be transmitted on the link 1.

At 707, a transmission status of the PDCP PDU (SN=n2) is requested for.

At 708, transmission on the link fails, for example, if the data packet is fragmented, the RLC PDU s2 in the data packet PDCP PDU (SN=n1) fails to be transmitted on the link 1, or if not being fragmented, the data packet PDCP PDU (SN=n1) fails to be transmitted on the link 1.

At 709, the RLC packet (for example, RLC fragment s2) that fails to be transmitted is returned, and information of PDCP PDU SN is contained.

At 710, the better link 2 is selected for retransmitting the RLC fragment s2 on the link 2, and information of the link 1 is contained for forwarding to the link 2.

At 711, the RLC fragment s2 is retransmitted on the link 2.

At 712, after the packet RLC PDU s2 is received, RLC fragments are re-assembled at a terminal, and subsequent signaling interaction is continued.

FIG. 9 shows a flow of a retransmission triggered by RLC, including the following operations.

At 801, a connection is established with a link 1.

At 802, data packets PDCP PDU (SN=n1, n2 . . . ) are transmitted.

At 803, the PDCP n1 is fragmented into RLC fragments s1, s2 and s3, or is not fragmented.

At 804, switching from the link 1 to a link 2 occurs, and meanwhile, a connection is established with the link 2.

At 805, transmission on a link fails, for example, if the data packet is fragmented, the RLC PDU s2 in the data packet PDCP PDU (SN=n1) fails to be transmitted on the link 1, or if not being fragmented, the data packet PDCP PDU (SN=n1) fails to be transmitted on the link 1.

At 806, the RLC packet (for example, RLC fragment s2) that fails to be transmitted is returned, and information of PDCP PDU SN is contained.

At 807, the better link 2 is selected for retransmitting the RLC fragment s2 on the link 2, and information of the link 1 is contained for forwarding to the link 2.

At 808, the RLC fragment s2 is retransmitted on the link 2.

At 809, after the packet RLC PDU s2 is received, RLC fragments are re-assembled at a terminal, and subsequent signaling interaction is continued.

With the foregoing solutions 1-5, fast retransmission of a PDCP or RLC packet in the case of multiple links may be implemented through interaction between a CU and a DU. Fast retransmission among the multiple links may be implemented, and retransmission of an RLC PDU on different links may also be implemented to avoid retransmission of the whole PDCP PDU.

When being implemented in form of software functional module and sold or used as an independent product, the integrated module of the embodiments of the application may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a personal computer, a server, a network device or the like) to execute all or part of the method in each embodiment of the disclosure. The storage medium includes various media capable of storing program codes such as a U disk, a mobile hard disk, a Read-Only Memory (ROM), a Random Access Memory (RAM), a magnetic disk or an optical disk. Therefore, the embodiments of the disclosure are not limited to any particular combination of hardware and software.

Correspondingly, an embodiment of the disclosure also provides a computer storage medium, in which a computer program is stored, the computer program being configured to execute a method for implementing multilink retransmission in the case of multiple connections according to the embodiments of the disclosure.

The above description is only for the preferred embodiments of the disclosure and not intended to limit the scope of protection of the disclosure.

### INDUSTRIAL APPLICABILITY

With the embodiments of the disclosure, the terminal accesses the at least two links; when the terminal fails to transmit the data packet on one link, the second network element reports the status report; and when the status report is analyzed to be that the data packet fails to be transmitted on the first link, the first network element selects the other link for data retransmission. When the terminal fails to transmit a data packet on one link in multiple links, the data packet that fails to be transmitted may be quickly retransmitted on the other link, so that retransmission of the data packet in the case of multiple connections for the terminal is implemented. The method is applied to retransmission processing in a CU-DU architecture of the access network where a first network element is a CU and a second network element is a DU, and is not limited to a scenario of the CU-DU architecture.

1. A method for implementing multilink retransmission in the case of multiple connections, comprising:
accessing, by a terminal, at least two links;
when a second network element finds at least one of the following situations: a data packet fails to be transmitted on a first link or the first link is abnormal, reporting, by the second network element, a status report; and
when the status report is analyzed to be that the data packet fails to be transmitted on the first link, selecting, by a first network element, other links for data retransmission.

2. The method of claim 1, further comprising:
allocating, by the first network element, a plurality of data packets obtained by splitting to the at least two links.

3. The method of claim 2, further comprising:
performing, by the second network element, fragmentation processing on the plurality of data packets to obtain a plurality of fragmented data packets, providing, by the second network element, the plurality of fragmented data packets to the at least two links for transmission.

4. The method of claim 1, wherein when the status report is analyzed to be that the data packet fails to be transmitted on the first link, selecting, by the first network element, the other links for data retransmission comprises:
selecting, from the at least two links, i links of which link transmission quality is higher than that of the first link, and retransmitting the data packet transmitted on the first link on the i links, i being a positive integer more than or equal to 1.

5. The method of claim 1, wherein when the status report is analyzed to be that the data packet fails to be transmitted on the first link, selecting, by the first network element, the other links for data retransmission comprises:
when the status report is analyzed to be that an xth fragmented data packet in the data packet fails to be transmitted on the first link, selecting, by the first network element, the other links for data retransmission, x being a positive integer more than or equal to 1.

6. The method of claim 5, further comprising:
selecting, by the first network element, i links of which link transmission quality is higher than that of the first link from the at least two links, i being a positive integer more than or equal to 1; and
forwarding, by the first network element, an identifier of the first link obtained from the status report to the i links, and retransmitting the xth fragmented data packet transmitted on the first link on the i links according to the identifier of the first link.

7. A base station, comprising a first network element and a second network element, wherein
the first network element is configured to: receive, in the case that a terminal accesses at least two links, a status report reported by the second network element when the second network element finds at least one of the following situations: a data packet fails to be transmitted on a first link or the first link is abnormal, and when the status report is analyzed to be that the data packet fails to be transmitted on the first link, select other links for data retransmission; and
the second network element is configured to report the status report.

8. The base station of claim 7, wherein the first network element is further configured to allocate a plurality of data packets obtained by splitting to the at least two links.

9. The base station of claim 8, wherein the second network element is further configured to perform fragmentation processing on the plurality of data packets to obtain a plurality of fragmented data packets, and provide the plurality of fragmented data packets to the at least two links for transmission.

10. The base station of claim 7, wherein the first network element is further configured to:
select, from the at least two links, i links of which link transmission quality is higher than that of the first link, and retransmit the data packet transmitted on the first link on the i links, i being a positive integer more than or equal to 1.

11. The base station of claim 7, wherein the first network element is further configured to:
when the status report is analyzed to be that an xth fragmented data packet in the data packet fails to be transmitted on the first link, select the other links for data retransmission, x being a positive integer more than or equal to 1.

12. The base station of claim 11, wherein the first network element is further configured to:
select, from the at least two links, i links of which link transmission quality is higher than that of the first link, i being a positive integer more than or equal to 1; and
forward an identifier of the first link obtained from the status report to the i links, and retransmit the xth fragmented data packet transmitted on the first link on the i links according to the identifier of the first link.

13. A method for implementing multilink retransmission in the case of multiple connections, comprising:
accessing, by a terminal, at least two links;
when a second network element finds at least one of the following situations: a data packet fails to be transmitted on a first link or the first link is abnormal receiving, by a first network element, a status report reported by the second network element; and
when the status report is analyzed to be that the data packet fails to be transmitted on the first link, selecting, by the first network element, other links for data retransmission.

14. The method of claim 13, further comprising:
allocating, by the first network element, a plurality of data packets obtained by splitting to the at least two links.

15. (canceled)

16. (canceled)

17. The method of claim 2, wherein when the status report is analyzed to be that the data packet fails to be transmitted on the first link, selecting, by the first network element, the other links for data retransmission comprises:
selecting, from the at least two links, i links of which link transmission quality is higher than that of the first link, and retransmitting the data packet transmitted on the first link on the i links, i being a positive integer more than or equal to 1.

18. The method of claim 3, wherein when the status report is analyzed to be that the data packet fails to be transmitted on the first link, selecting, by the first network element, the other links for data retransmission comprises:
selecting, from the at least two links, i links of which link transmission quality is higher than that of the first link, and retransmitting the data packet transmitted on the first link on the i links, i being a positive integer more than or equal to 1.

19. The method of claim 2, wherein when the status report is analyzed to be that the data packet fails to be transmitted on the first link, selecting, by the first network element, the other links for data retransmission comprises:
when the status report is analyzed to be that an xth fragmented data packet in the data packet fails to be transmitted on the first link, selecting, by the first network element, the other links for data retransmission, x being a positive integer more than or equal to 1.

20. The method of claim 19, further comprising:
selecting, by the first network element, i links of which link transmission quality is higher than that of the first link from the at least two links, i being a positive integer more than or equal to 1; and
forwarding, by the first network element, an identifier of the first link obtained from the status report to the i links, and retransmitting the xth fragmented data packet transmitted on the first link on the i links according to the identifier of the first link.

21. The method of claim 3, wherein when the status report is analyzed to be that the data packet fails to be transmitted on the first link, selecting, by the first network element, the other links for data retransmission comprises:
when the status report is analyzed to be that an xth fragmented data packet in the data packet fails to be transmitted on the first link, selecting, by the first network element, the other links for data retransmission, x being a positive integer more than or equal to 1.

22. The method of claim 21, further comprising:
selecting, by the first network element, i links of which link transmission quality is higher than that of the first link from the at least two links, i being a positive integer more than or equal to 1; and
forwarding, by the first network element, an identifier of the first link obtained from the status report to the i links, and retransmitting the xth fragmented data packet transmitted on the first link on the i links according to the identifier of the first link.
